(19) United States
(12) Patent Application Publication
(10) Pub. No.: US 2004/0148984 A1
(43) Pub. Date: Aug. 5, 2004

(54) Internal lock for automobile paddle-style door handle

(76) Inventor: Av Robertson, Chandler, AZ (US)

Correspondence Address: SANDRA L. ETHERTON, ETHERTON LAW GROUP, LLC, PO BOX 27843, TEMPE, AZ, 85285-7843, US

(21) Appl. No.: 10/355,329

(22) Filed: Jan. 31, 2003

(51) Int. Cl. E05B 13/00

(52) U.S. Cl. 70/211

(57) ABSTRACT

An improved lock for the inside of automobile cab doors having paddle-type door handles, particularly long-haul tractor cabs. The device is an L-shaped stop that is removably attached to the door handle from the inside. The short leg of the “L” fits between the paddle and the housing, thereby preventing the paddle from pivoting open. The stop is fitted with a keyed cylinder lock and a rotating dog, to secure it to the door handle. The stop substantially fills and fits snugly within the recessed cavity of the door handle, thus preventing thieves from inserting tools into gaps and prying the device loose. The device is also substantially flush with the door handle, or at least has no edge upon which to gain purchase, so there is no surface for thieves to strike and break the device off.

### FIELD OF INVENTION

This invention relates generally to automobile door handles. This invention relates particularly to a device for securing a door closed from the inside so that would-be thieves cannot open the door by breaking a window and opening the door from the inside.

### BACKGROUND

The cabs of long-haul trucks serve as truck drivers' homes-away-from home. The cabs often contain small treasure troves of televisions, computers, telephones, video tape or DVD players; movies, compact disks, clothing, jewelry, etc.

These cabs often have small glass windows near the foot well which increase visibility for the driver while parking the truck. The windows are problematic, however, because they are easily broken into. It has become common for thieves to break the window, reach inside through the window up to the door handle on the inside of the cab door, and open the door from the inside. The thief then steals what he or she desires from inside the cab and removes it through the open door.

Previous attempts have been made to secure a door closed in such situation, however the devices have suffered several drawbacks. For example, many of the proposed devices are permanently mounted to the automobile and, if removed, deface and damage the lock or the interior decor of the automobile, such as the side panel or arm rest. Since internal door locks are not necessarily used full-time, it is desirable to be able to easily install and remove the internal lock, and particularly to leave the interior unmarred upon the lock's removal. Another problem of prior art devices is that they are relatively easily pried loose or broken off, even from the awkward reach through the window, so that they provide only momentary improved protection. This is particularly true for the long-haul cabs mentioned above, where the thief uses a screwdriver or crow bar to pry the prior art lock off. Or, the thief simply uses the same crow bar, hammer or other tool that broke the window to break the internal lock off the door, and proceeds to rob the cab. It is desirable to provide an internal lock that is easily installed, not permanently mounted, easy for the rightful owner to remove, yet difficult for a thief to pry off or break.

Therefore, it is an object of this invention to provide a device for securing an automobile door closed from the inside. Another object of this invention is that the device is removably mounted, and does not leave the interior of the automobile marred upon removal. Another object of this invention is to provide an internal lock that is not easily pried or broken off by would-be thieves.

### SUMMARY OF THE INVENTION

The present invention is an improved lock for the inside of automobile cab doors having paddle-type door handles, particularly long-haul tractor cabs. The device is an L-shaped stop that is removably attached to the door handle from the inside. The short leg of the “L” fits between the paddle and the housing, thereby preventing the paddle from pivoting open. The stop is fitted with a keyed cylinder lock and a rotating dog, to secure it to the door handle. The stop substantially fills and fits snugly within the recessed cavity of the door handle, thus preventing thieves from inserting tools into gaps and prying the device loose. The device has no edge that juts out sufficiently to provide a surface upon which thieves might gain purchase to strike and break the device off.

### BRIEF DESCRIPTION OF THE DRAWINGS

FIG. 1 illustrates a perspective view of the cab of the tractor of a long-haul truck and a foot window.

FIG. 2 illustrates the interior face of the cab door.

FIG. 3 illustrates a front view of the door handle in a closed position.

FIG. 4 is a cross-sectional view of the door handle along line 4-4 of FIG. 3 with the paddle in a closed position.

FIG. 5 is a cross-sectional view of the door handle along line 4-4 of FIG. 3 with the paddle in an open position.

FIG. 6 shows an enlarged perspective view of the front of the lock.

FIG. 7 shows an enlarged perspective view of the rear of the lock.

FIG. 8 illustrates a front view of the door handle with the lock installed on a door handle.

FIG. 9 illustrates a cross-section of the door handle along line 9-9 in FIG. 8 with the lock installed.

FIG. 10 illustrates a cross-section of an alternate embodiment of the door handle along line 9-9 in FIG. 8 with the lock installed.

FIG. 11 illustrates a cross-section of another alternate embodiment of the door handle along line 9-9 in FIG. 8 with the lock installed.

### DETAILED DESCRIPTION OF THE INVENTION

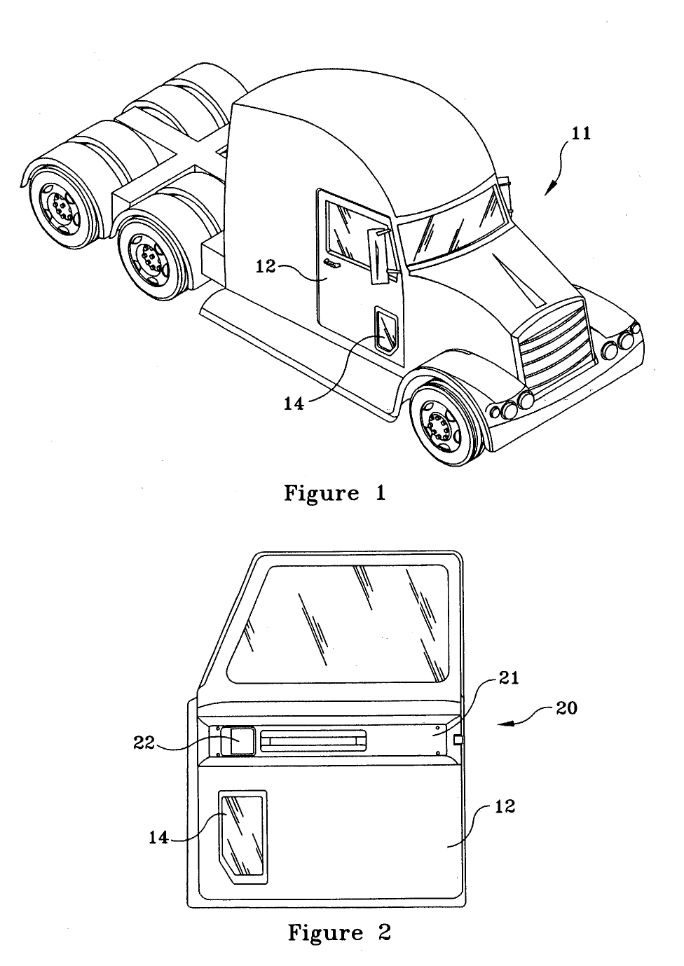

FIG. 1 illustrates a tractor cab 11 of a long-haul truck. The cab door 12 is fitted with a view window 14 near the foot well of the cab. The driver's side door may have a similar configuration, with a view window. To rob the cab, thieves break the window 14 and reach up though the window into the cab to unlock and open the door from the inside.

FIG. 2 illustrates the inside of the passenger door, showing that the door handle 20 is within a short distance—and easy reach—of the view window 14.

A conventional mechanical automobile door handle has an interior knob or grip connected to a rod or cable that is connected to a door latch. When the door handle is pulled, the rod or cable is also pulled, tugging on the latch, and the latch is released. For a power automobile door handle, the knob or grip is instead connected to an electronic actuator, and pulling the knob or grip releases the door latch via the actuator. For either type of door handle, preventing the knob or grip from being pulled will prevent the door from being opened from the inside. Conventionally the door handle also has a bar 24 that is conveniently located to open and close the door, as well as to hold onto when entering and exiting the truck. The bar 24 may also function as an arm rest.

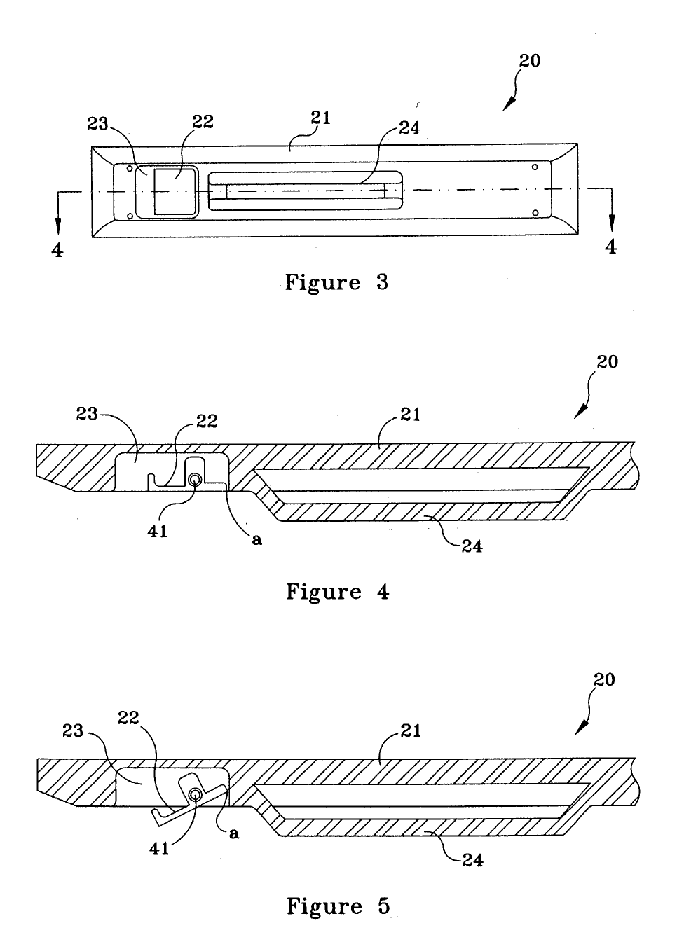

FIG. 2 illustrates the interior face of the cab door 12, that is, the side of the door that faces the inside of the cab 11. The door handle 20 of a tractor cab is comprised of at least a housing 21 and a hinged mechanism for releasing the door latch, illustrated herein as a rectangle and referred to hereinafter as a paddle 22. Differently shaped levers such as knobs and grips may also function to release the door latch, and are encompassed by the term paddle. The paddle 22, when pulled, will release the door latch (not shown) to open the door. The paddle 22 fits into an opening 23 in the housing 21. The opening 23 may be an aperture in the housing 21 or a closed cavity that is recessed into the housing 21 and adapted to receive the paddle. Typically the paddle 22 is off-set from the center of the opening 23 to allow for the passenger's fingers to fit behind the paddle to pull it open. For ease of operation and manufacturing, a gap is created between the paddle and the housing and typically the paddle does not fit snugly in the opening. FIG. 3 is an enlarged front view of the door handle 20, showing the paddle 22 in an opening 23 in the housing 21.

Typically the paddle 22 has a front edge that is closer to the hood of the cab, and a rear edge that is closer to the rear of the cab. The paddle 22 pivots about a vertical axis along an axle 41, which is typically between the center and the rear edge of the paddle 22. FIG. 4 illustrates a cross-sectional view of the door handle 20 showing the paddle 22 at rest. FIG. 5 shows the paddle 22 pivoted to an open position, with the front edge extending outwards from the door housing 21 and the rear edge rotated towards the door housing.

To open the door, the passenger puts his fingers into the opening 23 at the front edge of the paddle 22 and pulls the front edge of the paddle 22 outward from the housing 21. The paddle 22 pivots along the axle 41, activating the door latch (not shown). As the front edge moves out from the housing 21, the rear edge of the paddle 22 rotates in towards the door. The leading edge of the paddle 22 swings freely in the opening 23 and moves without touching the housing 21, at least until the door latch (not shown) is activated.

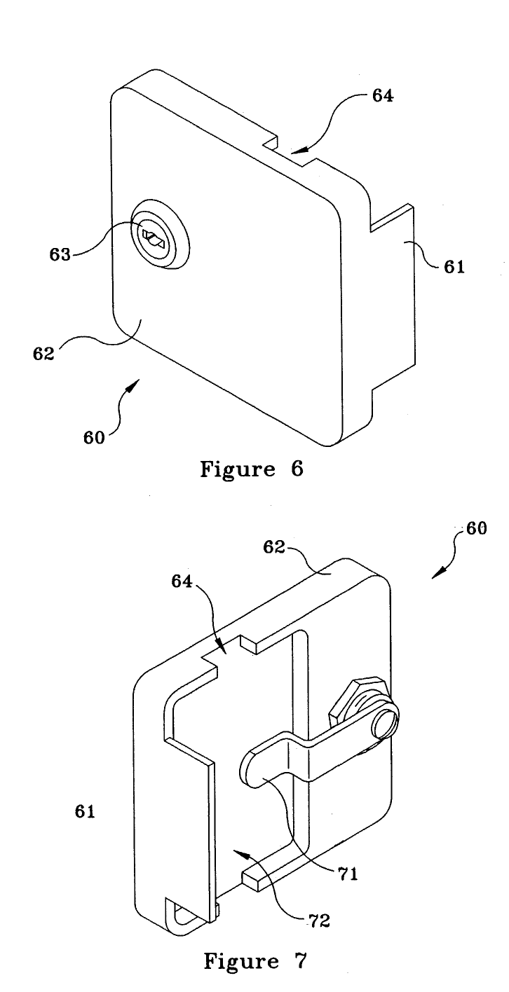

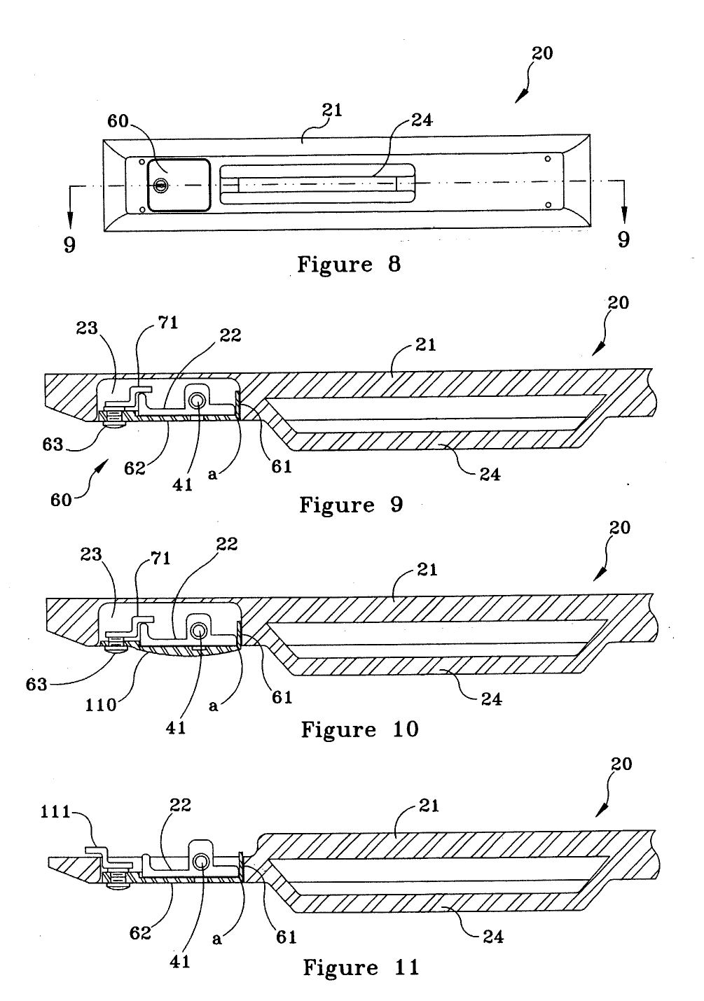

As best illustrated in FIGS. 6 and 7 the present device is an L-shaped stop 60 that has a short leg 61 and a long leg 62. The short leg 61 fits into the gap between the rear edge of the paddle and the housing 21. With this arrangement, if an attempt is made to pivot the paddle, the leading edge a of the paddle 22 comes in contact with the short leg 61 and the paddle 22 is blocked from pivoting further.

The L-stop 60 is shaped to fit snugly in the opening 23 and substantially fill all the gaps between the paddle 22 and the housing 21. By filling the opening and gaps, no tool can be inserted therein to attempt to pry the device from the door handle. In addition, preferably the device is adapted to receive the paddle such that when the device is installed, the long leg 62 is substantially flush with the housing 21, or at least has no edges that jut out sufficiently to provide a surface upon which thieves might gain purchase to strike and break the device off. FIGS. 6 and 7 show how this may be achieved, by forming a recess 64 for the paddle axle 41 and a recess 72 for the paddle itself. By making the device flush with the housing, as shown in FIGS. 9 and 11, the would-be thief cannot find purchase for a tool with which to pry the device from the door handle.

In the event the long leg 62 cannot be adapted to be flush with the door housing 21, for example when the paddle 22 protrudes from the opening past the plane of the housing, the long leg 62 can be curved around the paddle 22 to form a smooth surface so that no thief can find a purchase for a tool with which to pry the device from the door handle. FIG. 9 shows this second embodiment of this invention in which the long leg 62 is curved and extends outward from the door handle. The edges of the long leg 110 meet the housing such that substantially no gap remains between the device and the housing, and no edge or other surface is formed on which a tool can find leverage to pop the device from the door handle. The smooth surface also eliminates the problem of a thief striking a protruding part of the lock and breaking the device off; there are no protruding parts of the device.

The present device includes a latch 63 that is used to secure the device to the door handle. The latch 63 can utilize a rotating or sliding dog, and is preferably a cylinder lock with a rotating dog 71 that is mounted substantially flush with the long leg 62, so that no edge or other surface is formed on which a tool can find leverage to pop the device from the door handle. Preferably the dog 71 is rotated to fit behind the paddle 22 and secure the device to the paddle and preferably the dog is locked in place with a key (not shown). FIGS. 9 and 10 also show the dog 71 rotated to fit snugly behind the paddle 22. For doors that have an aperture instead of a recessed cavity in the housing, the latch 63 can secure the device to the housing 21 instead of the paddle, as shown in FIG. 11. With each of these embodiments, the device can easily be attached and removed without defacing the interior of the door.

In each embodiment, the device is smooth enough on the surface that faces the interior of the cab that a would-be thief cannot strike the device and find leverage enough to break the device off the door; the tool simply slides off. Plus, because the device fits snugly, there are no gaps for a would-be thief to insert a tool and pry the device loose. However, for these same reasons, a handle or grip of sorts is required for even the rightful owner to remove it. If a cylinder lock is used for the latch as explained above, the key serves not only to rotate the dog, but also to provide a grip to remove the device. In other words, the key becomes the handle for removing the device.

Alternate handles can be used. For example, a short pivoting arm can be used for a handle. At rest, the arm is normally substantially flush with the long leg, and may be spring biased or magnetized to keep it closed. The arm can be pivoted into an open position so that the arm can be grasped and the device removed from the opening. This arm may also be key locked, with a toothed key, a combination lock, or an electronic lock so that an authorized person can pivot the handle out and remove the present device.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. For a door handle having a paddle and a housing having an opening adapted to receive the paddle, a device comprising:
a) means for blocking the paddle from pivoting;
b) means for removably securing the device to the paddle; and
c) means for filling the opening so that substantially no gaps remain around the perimeter of the opening.

2. The device according to claim 1 wherein the device is substantially flush with the housing when it is secured to the paddle.

3. The device according to claim 1 wherein the means for removably securing the device to the paddle is a locking means.

4. The device according to claim 1 further comprising means for removing the paddle.

5. For a door handle having a paddle and a housing having an opening adapted to receive the paddle, a device comprising:
a) means for blocking the paddle from pivoting;
b) means for removably securing the device to the housing; and
c) means for filling the opening so that substantially no gaps remain around the perimeter of the opening.

6. The device according to claim 5 in which the device is substantially flush with the housing when it is secured to the housing.

7. The device according to claim 5 wherein the means for removably securing the device to the paddle is a locking means.

8. The device according to claim 5 further comprising means for removing the paddle.

9. For a door handle having a paddle and a housing having an opening adapted to receive the paddle, a lock comprising:
a) an L-shaped stop having a short leg and a long leg; and
b) a latch for removably securing the lock to the paddle;
wherein the short leg fits between the paddle and the housing and prevents the paddle from pivoting.

10. The lock according to claim 9 wherein the long leg fills the opening so that substantially no gaps remain between the stop and the perimeter of the opening.

11. The lock according to claim 9 wherein the lock is substantially flush with the housing when it is secured to the paddle.

12. The lock according to claim 9 wherein the long leg is shaped to receive the paddle.

13. The lock according to claim 9 wherein the latch is a keyed cylinder lock.

14. The device according to claim 9 further comprising a handle for removing the lock which, at rest, is substantially flush with the device.

15. For a door handle having a paddle and a housing having an opening adapted to receive the paddle, a lock comprising:
a) an L-shaped stop having a short leg and a long leg; and
b) a latch for removably securing the lock to the housing,
wherein the short leg fits between the paddle and the housing.

16. The lock according to claim 15 wherein the long leg fills the opening so that substantially no gaps remain between the stop and the perimeter of the opening.

17. The lock according to claim 15 wherein the lock is substantially flush with the housing when it is secured to the housing.

18. The lock according to claim 15 wherein the long leg is shaped to receive the paddle.

19. The lock according to claim 15 wherein the latch is a keyed cylinder lock.

20. The lock according to claim 15 further comprising a handle for removing the lock which, at rest, is substantially flush with the lock.
